(19) United States
(12) Patent Application Publication
(10) Pub. No.: US 2007/0182529 A1
(43) Pub. Date: Aug. 9, 2007

(54) Method and apparatus for influencing the load of a driver in a motor vehicle

(75) Inventors: Guenter Dobler, Altbach (DE); Ercan Ellitok, Ulm (DE); Volker Entenmann, Affalterbach (DE); Wolfgang Gottlieb, Berlin (DE); Klaus-Peter Kuhn, Pluederhausen (DE); Michaela Ludwig, Ostfildern (DE); Andreas Proettel, Schwaikheim (DE); Siegfried Rothe, Denkendorf (DE); Dimitra Theofanou, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/557,201

(22) PCT Filed: Apr. 20, 2004
(86) PCT No.: PCT/EP04/04171

§ 371 Date: Mar. 14, 2007

(30) Foreign Application Priority Data
May 16, 2003 (DE) 103 22 458.0

(51) Int. Cl. B60Q 1/00

(52) U.S. Cl. 340/438

(57) ABSTRACT

A method for influencing the load on a driver while driving a motor vehicle, in which a workload is determined from physiological driver data detected by sensors, and to an apparatus for carrying out the method. The load or the workload on the driver is kept in an optimum workload range and brought back to this optimum range if there is any discrepancy, thus ensuring an optimum driver performance level and attention level. For this purpose, vehicle systems are driven as a function of the detected workload value in such a way that the driver is influenced via his visual, auditory or tactile sense channels in such a way that his workload value returns to a value in the optimum workload range.

This application claims the priority of PCT/EP2004/004171, filed Apr. 20, 2004 which claims priority to German Application No. 103 22 458.0 filed May 16, 2003, the disclosure of which is expressly incorporated reference herein.

### BACKGROUND AND SUMMARY OF THE INVENTION

The invention relates to a method for influencing the load on the driver while driving in a motor vehicle in which a workload is determined from physiological driver data which is detected by means of sensors. The invention also relates to an apparatus for carrying out this method.

Japanese reference_JP 2002 010 995 A describes a method for determining the workload on a driver while driving in a motor vehicle, using physiological driver data, to be precise his heart rate and breathing rate. The evaluation of the data leads to classification on the basis of mental load, physical load and normal load in the form of a respective numerical value. The current driver situation is allocated to a category with a specific workload as a function of the ratio of the magnitudes of these values, and a driver assistance action is selected as a function of this value by, for example, automatically activating an anti-collision control system (ACC), an automatic braking system or a lane changing assistant, in order to reduce the load from his driving tasks on the driver. This method also provides for acoustic or visual warning signal to be produced at specific driver workloads. This Japanese document also describes an apparatus for carrying out this known method.

In addition, German document DE 100 42 367 A1 discloses a method and an apparatus for diagnosis of the fitness of the driver to drive a motor vehicle, using physiological driver data which is recorded while driving is likewise used to assess the driver state, and is combined with data about the instantaneous driving state of the vehicle or with data about the instantaneous traffic situation, with this being used to estimate the fitness of the driver to drive, if appropriate with warnings based on this estimate of the fitness to drive being emitted to the driver, and with remedial measures also being initiated if necessary. This method also proposes that, in addition to the currently measured physiological driver data, his health-relevant data, obtained outside the vehicle, in particular his biographical data, additionally be used for estimation of the current driver load. If overloading is found or it is found that the load on the driver is not adequate for the situation, a method is proposed in this known document to allow an appropriate emergency call signal to be sent, for example by GSM radio, in order to allow remedial measures to be initiated.

Physiological driver data can be recorded, for example, via appropriate sensors on the vehicle steering wheel, as is known, by way of example, from German reference DE 195 45 848 A1. In addition, physiological data can also be determined by means of video recordings in order, for example, to make it possible to derive a statement about a driver state from the eyelid blinking frequency, as is described in the already cited DE 100 42 367 A1. Finally, sensor systems in accordance with the abovementioned JP 2002 010 995 A for measurement of the heart rate can be accommodated in the seatbelt.

German document_DE 100 39 765 A1 discloses a method for warning a driver of a vehicle, in which the vehicle driver's attention is determined before a warning is emitted, with a warning being emitted only as a function of the determined degree of attention before a critical situation, that is to say, by way of example, even by suppressing this output if a high attention level is determined. In this case, the driver's attention is determined by detection of the viewing direction, the eyelid blinking frequency and/or the head position. The process of determining the attention also includes the secondary activities carried out by the driver in addition to his driving task, such as control and use of audio equipment, navigation systems or mobile radio devices. Finally, a fatigue state is determined by measuring the body temperature and/or the heart rate of the driver, and this is used to determine the attention level of the driver. In this known method, warnings are emitted not only as a function of the determined attention level of the driver, but also as a function of the vehicle state, so that critical vehicle state situations are identified by means of assistant systems, such as parking aids, anti-collision control systems (ACC) and side-strip identification, and warning messages are produced earlier or later as a function of the detected attention level of the driver. Physiological driver data, such as the heart rate and body temperature, are also recorded by means of sensors arranged on the steering wheel in this known method.

Furthermore, German Patent document DE 199 52 857 C1 discloses an apparatus for controlling vehicle components and optical or acoustic signaling devices as a function of the driver state, with the driver's state being identified by evaluation of the driver's face, recorded by a camera, and by evaluation of the driver's voice, recorded by a micro-phone. Information filtering for information to be presented and, if necessary, emergency functions or assistance functions for the driver are also activated as a function of the determined driver state. Thus, for example, an emergency call can be made via a communication device as an emergency function when, for example, the driver is suffering a collapse. As a secondary function, it is possible to produce soothing music when the driver is in a stress situation, by playing appropriate audio media of a play back device which is connected to the car radio, or by selecting a broadcast radio transmitter which is transmitting corresponding music. Furthermore, an automatic braking system can be activated as a function of the driver state, in which case it is possible to distinguish between emergency situations and other situations. For example, its activation in an emergency, for example in the event of the driver collapsing, leads to slow braking being carried out thus preventing further acceleration of the vehicle, by the clutch being disengaged at the same time.

Furthermore, German Patent Document DE 197 53 160 C1 discloses an apparatus for identification of an eminent vehicle accident situation, in which an image identification system is used to detect changes in the movement of the hands and, from them, the rate at which the movement changes are being carried out. If these movement changes indicate panic-like movement, at least one safety system is activated. In this case, the empirical assumption is made that the drivers who identify an eminent accident situation turn the steering wheel in a panic-like manner in order to avoid the accident situation. In addition to detection of the movement of the hands, it is also possible to detect the movement of the driver's feet operating the accelerator pedal and brake pedal, and likewise to use this to initiate a safety system when the movement rate of a foot exceeds a predetermined threshold which indicates a driver panic reaction.

According to U.S. Pat. No. 6,061,610 workload on a driver is determined by using a steering angle sensor to record the steering angle while driving, with this steering angle pattern being compared with a standard pattern which corresponds to the steering angle pattern of an unstressed driver. A load index value is produced as a function of the comparison result.

Furthermore, German Patent Document DE 198 18 239 A1 discloses an apparatus for warning that the driver of a motor vehicle is going to sleep, which apparatus comprises a vehicle environment identification device, a device for recording a reference driving style of the driver, comparison logic for evaluation of the reference driving style with an actual driving style determined by the vehicle environment identification device, and a warning device which can be driven by the comparison logic. If lateral movement of the motor vehicle with respect to the roadway boundary is identified on the basis of the evaluation of the data by the vehicle environment identification device, then this lateral movement is compared by means of the comparison logic with the reference driving style and, if a threshold value is exceeded, a warning device is driven to produce a tactile, acoustic or optical warning signal.

Finally German Document DE 101 34 223 A1 discloses an air replenishment unit for motor vehicles, which allows olfactory modification of the air in the vehicle interior, and can either be operated manually or else can be selected automatically in order to warn the driver via his sense of smell in vehicle-critical states—for example if the coolant/oil temperature is high, the tire pressure is too low or the ABS has failed. In the last-mentioned case, it is proposed that the driver performance is then increased by increasing the oxygen supply, or by positively influencing him by means of appropriate olfactory modification.

These known methods and apparatuses are used essentially to warn the driver in danger situations or to reduce the load by appropriate control of vehicle systems in situations such as these. In this case, danger situations are identified as being those when an extreme driver state is detected, that is to say either a risk of going to sleep, overloading or driver collapse, with overloading also being assumed in extreme traffic situations. The appropriate measures are thus taken only to avoid a danger situation that has already occurred.

The invention is thus based on the object of specifying a method for influencing the load on a driver while driving in a motor vehicle, which provides measures even before the occurrence of extreme danger situations, so that the risk of occurrence of a dangerous situation or situation leading to an accident is in this way prevented, or is at least reduced.

According to the present invention the solution includes the use of automatically produced measures, with the aid of systems in the vehicle, which are used to continuously ensure that the driver is in an optimum load or workload state in which, at the same time, he can operate with maximum performance.

The invention is based on the idea that, if there is a discrepancy from this optimum load or workload state, the driver performance also deteriorates, say when the load or the workload both decreases and increases away from this optimum state. An extreme load or workload state in which the driver's performance deteriorates to virtually zero is represented both by the sleeping state when underloaded and by the driver collapsing when absolutely overloaded.

According to the invention, the workload of the driver is determined and is compared with the optimum workload, the so-called intended workload. If the determined workload is less than the predetermined intended workload, the driver is underloaded, which can result in an excessively low attention level, leading to a drop in performance. According to the invention, the load on the driver is increased by producing visual and/or audible and/or tactile and/or olfactory signals by controlling at least one vehicle system, and/or by increasing visual and/or audible and/or tactile and/or olfactory signals which have already been produced, and/or by changing their signal quality by controlling at least one vehicle system. These signals are thus used to increase the load on the driver so that he is once again capable of optimum performance. If, however, the determined workload is greater than the intended workload, the driver is overloaded, and this likewise leads to a drop in performance. According to the invention, the increase in the load of the method is prevented by providing driver information and/or display systems in the motor vehicle in such a way that the output of visual and/or audible and/or tactile and/or olfactory signals is completely or partially suppressed, or they are output at a later time. The partial suppression of these signals leads to a reduction in the amount of information and, in precisely the same way as withholding information, can prevent a further rise in the load in an instantaneous driver overload situation.

When the driver is overloaded, the invention provides for the signal strength and/or signal quality of visual and/or audible and/or tactile and/or olfactory signals which have already been produced to be reduced or to be changed by controlling at least one vehicle system, and/or for the use of a driver assistance system to be offered by outputting appropriate information to the driver. The aim of this is to return the driver to a state of optimum performance, that is to say his workload returns to the optimum intended workload range.

According to the invention the overloading of the driver is also reduced by reducing or changing the signal strength and/or the signal quality of a visual and/or audible and/or tactile and/or olfactory signal which has already been produced, by controlling at least one vehicle system, and/or by activating at least one driver assistance system.

The invention makes it possible to considerably improve the driver behavior safety by using the load, also referred to in the following text as the “workload”, as detected by technical means and as determined quantitatively as a controlled variable and to use technical systems in the vehicle as regulation means to produce or change signals as a function of any discrepancy from an optimum driver workload, in which the driver performance is at an optimum level, in particular an optimum attention level, bypassing such signals to the driver on one or more of his sense channels, specifically the auditory, visual or tactile sense channels, thus either increasing or reducing the workload in the direction of the optimum value as the regulation result.

The signals which are used as regulation means can preferably also be produced or changed in such a way that different sense channels of the driver are addressed successively—that is to say a modality change takes place—for example by first producing a visual signal followed by an audible signal or vice versa, by first producing a tactile signal, and then an olfactory signal.

In one advantageous development of the invention, the determined workload is compared with an intended workload which is defined by a lower and an upper intended workload so that, at these values, the load on the driver is just still acceptable and a performance level and attention level of about 80% can thus be assumed, in which case these values (the upper and lower intended workloads) are variable and can be set individually for the driver. The regulation mechanism therefore acts only when the upper intended workload is exceeded or the lower intended workload is undershot.

In addition, workload limits are also defined, which indicate the minimum and maximum load or workload on the driver. For example, when the minimum workload limit is undershot, there is a risk of going to sleep, so that in this case wake-up signals are produced. Provision is also made for a vehicle danger state to also be indicated to other road users by appropriate warning signals. If the upper maximum workload is exceeded, other road users can likewise be warned, since it is assumed that the driver is overloaded and that there is also a risk of collapse. As a secondary measure for the driver, an automatic braking system in the vehicle can be activated in order, for example, to prevent further acceleration of the vehicle, or else to automatically and continuously reduce the speed.

Measures for prevention of further increases in the load on the driver preferably comprise the prioritization of warning messages and the use of driver information systems to suppress relatively low priority warning messages, or to output them at a later time. Messages about the reception of telephone calls, SMS messages, E-mails or traffic messages can also be dealt with in a similar manner.

Measures for controlling the illumination of displays can lead to the same result by prioritizing the displays in a vehicle display system and switching off the illumination for a relatively low priority display, or by reducing its light intensity, in order in this way to prevent the load on the driver being increased further.

The vehicle climate control can also advantageously be used in increase or reduce the workload on the driver. In this case, the climate control relates not only to the air-conditioning system but also to the seat heating, seat ventilation, heating during parking and steering wheel heating. One vitalizing measure which leads to a workload increase is, for example, to set a cooler temperature, to increase the fan effect, or to change the fan direction, or to switch on the steering wheel heating or increase the temperature of the steering wheel heating. Measures to reduce the workload on the driver may, for example, be to switch on the air-conditioning system when a high internal temperature is detected, while a lower temperature for the seat heating, switching off the steering wheel heating or else a more pleasant setting of the fan effect can be used to achieve the same effect.

A further advantageous development with regard to vehicle systems to increase or to reduce the load on the driver includes controllers for the driver's seat being driven in such a way that a more comfortable seating position is made possible by adjustment of the seat backrest in order to reduce the workload, or the seat hardness is increased, on the other hand, in order to increase the workload. The same effect can also be achieved by means of a driving-dynamic seat, in which the side support for the driver is changed by inflation or deflation of side parts of the seat backrest in bends. The use of an orthopedic seat is also effective, which produces a stimulating effect in a massage position by means of pulsating inflation and deflation, thus increasing the workload.

Audio systems in the vehicle can also be used to increase or to reduce the load on the driver, for example by reducing the volume, making the tonal quality more pleasant or else by muting amplitudes in order in this way to reduce the load on the driver. A corresponding workload increase can be achieved by the opposite measures.

Appropriate control of the lighting devices in the vehicle can also be used to influence the load level on the driver, for example by making the instrument illumination brighter in order to increase the workload, or by reducing the brightness in order to achieve the opposite effect, that is to say to achieve more restful lighting.

One workload reduction measure may also include appropriate driving of door controllers, the closure of side window or the sliding roof in order in this way likewise to reduce the workload on the driver since the noise level is lower when the interior is closed than when the side windows are open and/or the sliding roof is open.

One particularly advantageous development with regard to the vehicle system which is used to increase or to reduce the load on the driver is to offer the driver an easier route, by means of a navigation system, when the workload is high. In order to achieve the opposite effect, a more difficult route can be offered in order to reach the journey destination. In addition, information provided by the navigation system also be displayed in order to increase the workload, such as parking lots or particularly attractive hotel facility in the vicinity.

It is, of course, particularly advantageous to use the information systems in the vehicle to increase or to reduce the load on the driver. For example, widely differing information of the general type or specific to the vehicle can be offered in this way in order to increase the workload on the driver, or the information flow can be reduced to what is necessary in order to achieve the opposite effect. A controller for the anti-collision system (ACC system) can also advantageously be used to increase or to reduce the load on the driver. For example, an increase in the safety separation or a reduction in the speed setting thus lead to a reduction in the load on the driver. The opposite measures of course lead to an increase in the workload. Measures such as emission of a warning at an increased volume or else entirely switching off this ACC controller likewise lead to a workload increase.

Furthermore, a suspension controller can be used to set softer or harder damping, in order to reduce or increase the workload.

Controllers for road sign identification are also suitable for this purpose, for example by setting the road sign identification to identify all road signs in order to increase the workload, while only relevant road signs are displayed in order to achieve the opposite effect.

One particularly advantageous measure in order to increase the workload is to use controllers for adjustment of the steering wheel position or for production of steering vibration. A controller for the servosteering can also be used for this purpose, for example by setting the steering to be heavier.

Finally, the workload on a driver can be influenced particularly effectively by means of assistance systems in the vehicle. For example, their use can be offered in order to reduce the load on the driver, or these systems can be switched on automatically when the workload levels are particularly high. An increase in the load can easily be achieved by switching off such assistance systems.

In this context, assistance systems can be regarded as being curve warning systems, lane changing assistants, lane assistants which automatically keep the vehicle in the lane, stop and go assistants, automatic braking systems which automatically prevent acceleration or initiate a braking process, braking assistants which produce a braking force effect as a function of the rate at which the brake pedal is operated, or else night-vision appliances based on infrared identification.

The load on the driver is determined on the basis of physiological data, such as the heart rate, blood pressure, skin impedance, as well as variables such as view movement, eyelid blinking times and the rate of eyelid blinking. Driver biological data can also be used to determine the workload, as well as data relating to the disposition of the driver, such as the driving style in terms of acceleration, steering or braking.

In addition to the disposition of the driver, the reason for the load may be related to vehicle control, which in this case includes not only vehicle state data but also environmental data relating to the type of road, the road state, the traffic and the environmental conditions. The recording of such data and its inclusion in the determination of the workload on the driver leads to a considerable improvement in the claimed method.

The driver's driving maneuvers and/or driver action are also used to improve the determination of the workload on the driver. In this case, severe acceleration or deceleration, rapid approach to a vehicle traveling in front, a short separation in the direction of travel or severe steering movements are recorded as driving maneuvers. In contrast, driver actions represent control sequences which relate, for example, to seat adjustment, making telephone calls or navigation, the operation of the radio or operation of the air-conditioning system.

Finally, if it is found that the driver is underloaded and the load on the driver is increased, it is possible, in particular even before the load on the driver is increased, to inform him of the change in load, for example by appropriate control of the driver information and display system, in order to produce visual and/or audible signals.

A claimed apparatus is specified in order to carry out the method according to the invention, in which a sensor unit is provided for detection of the vehicle driver's physiological data and is connected via a bus system to an on-board computer for determining and evaluating the workload on the driver, in which case a workload control unit drives at least one vehicle system in accordance with the measures associated with the evaluation result on the basis of the evaluation result which is produced by the on-board computer and the measures which are stored in a measure memory. Vehicle state and vehicle environment sensors are preferably provided, and are connected to the on-board computer. Furthermore, the on-board computer is also connected to an input appliance for inputting the driver's biographical data. Such an input appliance could also be used to input disposition data, such as fear of bridges, fear of tunnels and certain preferences, such as the preferred output medium. Finally, a driver activity sensor system can also be connected to the on-board computer in order, for example, to detect his driving style.

### BRIEF DESCRIPTION OF THE DRAWINGS

The invention will be described in more detail in the following text and will be explained in more detail by means of exemplary embodiments.

FIG. 1 shows a workload/performance diagram in order to describe the workload-dependent performance of a driver,

FIG. 2 shows a functional diagram in order to explain the method operation of the invention, and

FIGS. 3a and b show a block diagram in order to explain the method of operation of one exemplary embodiment.

### DETAILED DESCRIPTION OF THE INVENTION

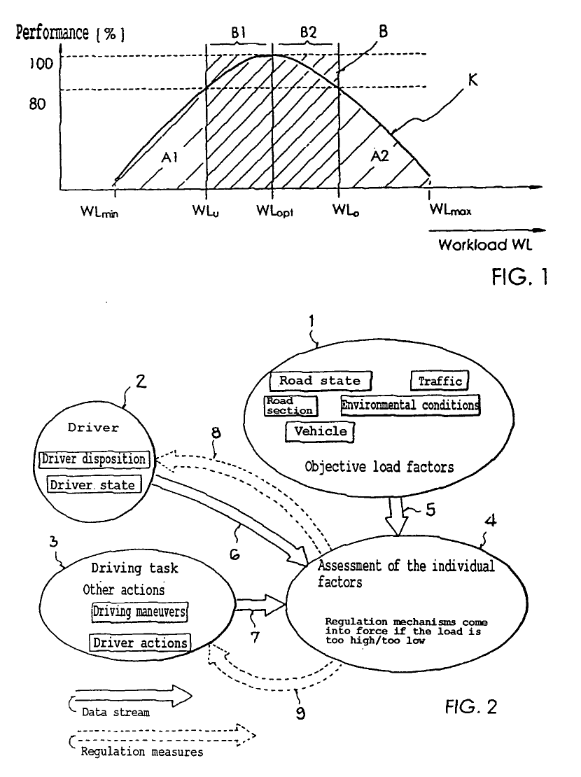

FIG. 1 uses a load curve K to show the relationship between the performance or the performance capability of a driver and his workload WL. This curve K is approximately in the form of Gaussian bell curve with its maximum at a workload value WL of WLₒₚₜ because it has been found that there is one such optimum workload at which the driver achieves his optimum performance, i.e. an optimum attention level, which is annotated by 100% on the performance/workload diagram. Starting from this optimum workload value WLₒₚₜ, both an increase in the load of the workload on the driver and a reduction lead to a drop in performance and to a reduced attention level. Furthermore, an intended load range B1 or B2 is defined by a lower workload WLᵤ and an upper workload WLₒ, and is defined such that the corresponding workloads still lead to an acceptable driver performance level. In FIG. 1, these two values WLᵤ and WLₒ are defined such that a performance level of at least 80% can be achieved.

Furthermore, a lower minimum workload limit WLₘᵢₙ and an upper maximum workload limit WLₘₐₓ are respectively defined at each end of the curve K, and each indicate an absolute driver workload limit. If the workload value is found to be below the lower minimum workload limit WLₘᵢₙ then there is a risk of the driver going to sleep. In the opposite situation, that is to say when the workload value is above the upper maximum workload limit WLₘₐₓ this means that the driver is completely overloaded, and that there is a risk of the driver collapsing.

If a workload WL is now determined which is either in the range A1 defined by the values WLₘᵢₙ and WLᵤ or is in the range A2 defined by the values WLₒ and WLₘₐₓ, vehicle systems are automatically driven in such a way that this results in an increase or reduction in the load or workload on the driver, as a consequence of which the load on the driver is returned to the optimum workload range B1 or B2.

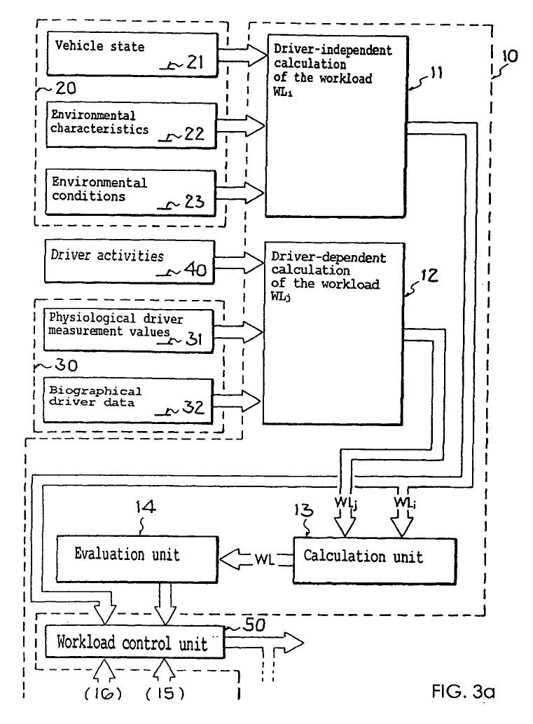

The diagram in FIG. 2 shows the relationship between the factors which govern the workload on the driver, whose recording is used as data material for determination of the workload, and the regulation measures for workload optimization, i.e. the measures for influencing the load on the driver, in order to keep his performance at a high level. Objective load factors (reference symbol 1) which relate to the road state, the traffic, the type of road, the environmental conditions and the vehicle state, are recorded in order to determine the workload (reference symbol 4). These factors are detected by means of sensors, and are subjected to evaluation, as data material 5. In a corresponding manner, driver-related state data 2 is detected by means of sensors, and is likewise subjected to evaluation, as a data stream 6. In this case, relevant data includes the driver disposition and the driver state. Finally, the driving task and other driver actions (reference symbol 3) represent the final load source, with driving maneuvers by the driver and driver actions being detected as data 7 to be evaluated.

All the load factors are now subjected to evaluation on the basis of the data items 5, 6 and 7, and the workload is determined from this. Regulation measures 8 and 9 are produced both in the case of an excessively high and excessively low workload, that is to say when a value such as this is located in one of the areas A1 or A2 shown in FIG. 1, which regulation measures 8 and 9 influence the driver 2 or change his driving task in such a way that this once again results in a workload which is in the areas B1 or B2 as shown in FIG. 1.

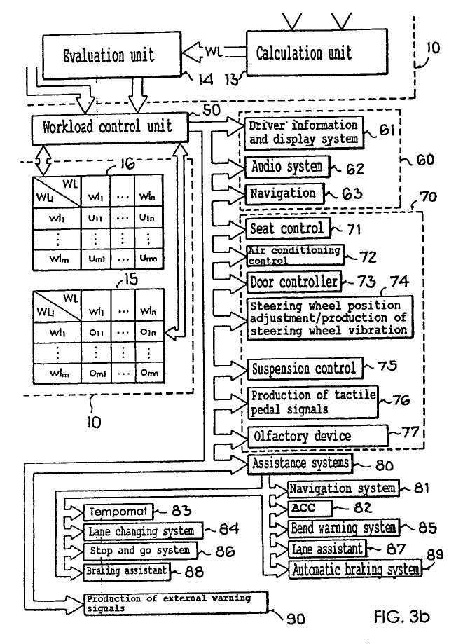

The block diagram in FIGS. 3a/3b shows the functional units in a vehicle by means of which the relevant load factors on the driver are determined, with workloads being calculated from the corresponding data material in order to initiate appropriate regulation measures to influence the load on the driver as a function of the comparison with a predetermined intended workload WLₒₚₜ (see FIG. 1).

As can be seen from these FIGS. 3a/3b, state data is determined by means of sensor units 20, 30 and 40 and is supplied to an on-board computer 10 for evaluation. This on-board computer 10 is followed by a workload control unit 50, which drives various vehicle systems 60, 70, 80 and 90 on the basis of the evaluation result.

The sensor unit 20 detects objective load factors relating to the vehicle state 21, environmental characteristics 22 and environmental conditions 23. The measurement variables determined for recording of the vehicle states may include the speed, acceleration, driving-dynamic variables, such as the yaw rate, roll angle, pitch angle, steering wheel angle, steering wheel torque, rate of change of the steering wheel angle, acceleration of the steering wheel angle, ESP and ABS operating state, longitudinal dynamic variables such as pedal positions, engine torque, braking torque, engine rotation speed, selected gear, clutch and kick-down state. Furthermore, it is also possible to record noise levels in the vehicle, the vehicle mass, the load state, whether a trailer is attached, whether the screen washer water is low, whether there is a defective light, the tire state, the tire pressure, whether winter tires are fitted, or whether the headlights are dirty. Appropriate sensors are generally already fitted in the vehicle in order to record the stated measurement variables.

Environmental characteristics 22 relate to the nature of the road, that is to say a through road, a county road, a road within a built-up area, and the road profile, recorded in terms of the variables comprising the bend profile, ascent/descent, road surface/road state, road width, lane grooves, and traffic density. Local events, such as entering/leaving a tunnel, a crossing, traffic circles, pedestrian crossings, traffic lights, speed limits, road signs, bridges, railway crossings, pedestrian zones, play streets, building sites, chicanes and parking facilities can also be recorded by means of an appropriate sensor system.

The environmental conditions 23 relate essentially to the lighting and/or visibility, the signaling and the climatic conditions. Relevant measurement variables for this purpose may include the operating state of the individual light sources, in particular including the fog light, being recorded, and relevant variables can be determined by means of a light sensor, a sunlight sensor, or a rain sensor. Important measurement variables also include the time of day, the time of year, and the geographical location. Operating states of the blinkers, warning blinkers and horn are detected in terms of signaling. The outside temperature, the inside temperature, the selected temperature and the state of the seat heating are recorded in order to determine the climatic state.

The data detected by the sensor unit 20 is supplied to the unit 11 in the on-board computer 10 in order to calculate the driver-independent workload WLᵢ.

The sensor unit 40 for detection of driver activities includes data relating to the driving maneuvers carried out by the driver as well as driver actions. The measurement variable “driving maneuver” covers, for example, severe acceleration or deceleration, severe steering movements, lane changes or turns, and in the end also the driving style of the driver. In contrast, driver actions relate essentially to the secondary task of the driver, that is to say in particular the control of the vehicle systems. This includes, for example, control sequences relating to seat adjustment, use of the telephone, control of the navigation system, mirror adjustment, control of audio/multimedia appliances or control of the air-conditioning system. The measurement variable and “driver activities” also includes the recording of the operating state of driver assistance systems. In this case, for example when an anti-collision control system (ACC system) is active by way of example, it is possible to record rapid approach to a vehicle traveling in front or a short separation from the vehicle in front in the direction of travel.

Subjective driver load factors are detected by the sensor unit 30, for example physiological driver data such as blood pressure, heart rate, eyelid blinking times, eyelid blinking rate and view movement. Biographical data can also be determined and/or entered via an appropriate input appliance 32, such as age, gender, as well as driving disposition characteristics, such as fear of bridges, fear of tunnels and certain preferences such as the preferred output media, driver nervousness or else handicaps such as whether the driver is wear glasses.

The data detected by the sensor units 30 and 40 is supplied to a further unit 12 in the on-board computer 10 in order to calculate a driver-dependent workload WLⱼ.

The workloads WLᵢ and WLⱼ determined by the units 11 and 12 are supplied to a calculation unit 13 which uses them to determine an overall workload WL. An evaluation unit 14 following the calculation unit 13 evaluates this workload WL by comparing this value with the values described in conjunction with FIG. 1, these being the lower intended workload WLᵤ, the upper intended workload WLₒ, the lower minimum workload limit WLₘᵢₙ and the upper maximum workload maximum WLₘₐₓ. This evaluation result is supplied together with the driver-independent workload WLᵢ to the workload control unit 50. The workload control unit 50 uses two tables 15 and 16, which are stored in a memory in the on-board computer 10, to determine which of the vehicle systems 60, 70, 80 or 90 are being driven, and in what way.

The Table 15 associates a corresponding measure oₗₖ (1=1, . . . , m, k=1, . . . , n) with each value pair comprising a workload WL and a driver-independent workload WLᵢ. The corresponding workload values for the workload WL are annotated WLₗ to WLₙ, with a low index indicating a lower load than a value with a higher index. The values for the driver-independent workload WLᵢ are annotated WLₙ to WLₘ in which case, once again, values with a low index indicate a lower load than values with a higher index. The workloads WL in this Table 15 are, however, values which are below the lower intended workload WLᵤ. The associated measures Oₗₖ thus represents measures to increase the driver workload.

Table 16 differs from Table 15 only in that the values WLᵢ to WLₙ of the workload WL are above the upper intended workload WLₒ (see FIG. 1), and the corresponding measures uₗₖ (1=1, . . . , m, k=1, . . . , n) are thus measures to reduce the driver workload.

The operation of the workload control unit 50 will be explained in the following text using specific examples and in conjunction with Tables 15 and 16, with the driving of the vehicle systems 60, 70, 80 and 90 being illustrated and explained.

If, by way of example, it is detected that the driver will have to cope with a difficult section of the route in the next few seconds, this situation is assessed to have a medium driver-independent workload value WL₁ and the driver has already coped with a difficult driving maneuver, which likewise leads to a medium workload WL, the associated measure uₗₖ may, for example, comprise preventing further increase in the driver workload. The following measures uₗₖ can be provided for this purpose:
Partial or complete suppression or change in the timing of the output of warning messages with a relatively low priority, achieved by appropriate driving of a driver information and display system 61 by the workload control limit 50,
reduction in the light intensity of the display instruments with a relatively low priority or switching off this illumination, achieved by the already mentioned driver information and display system 61,
no reception or indication of incoming telephone calls, SMS messages or incoming E-mails, but optionally passing on to a mailbox instead, likewise achieved by the driver information and display system 61, and
partial or complete suppression or changing of the display of traffic messages which are received via the radio of an audio system 62 or via a navigation system 81.

If difficult traffic and road conditions lead to a medium to high driver-independent workload WLₖ and a high driver-dependent workload WLₖ also occurs at the same time, then measures oₗₖ from the Table 15 are initiated by the workload control unit 50 by controlling appropriate vehicle systems 60, 70, 80 or 90 in order to reduce the workload.

The following measures oₗₖ are used for this purpose:
less stressful climate control is selected by means of a climate controller 72: the vehicle air-conditioning system is controlled to reduce the temperature in the interior or to reduce the fan effect or to change the fan direction, so that it no longer strikes the driver's face, the seat heating is regulated at low temperatures or the seat heating is switched off, seat ventilation is activated or increased, parking heating is controlled to low values or the parking heating is switched off, or steering wheel heating is controlled to low values or is switched off,
the seat backrest position is changed by means of a seat controller 71 such that the driver can assume a more comfortable seating position, or the seat cushioning is made softer or, in the case of a driving-dynamic seat, is controlled such that better side support is possible,
the suspension is set to soft springing by means of the suspension control 75,
an audio system 62 is adjusted so as to reduce the volume, to make the tone softer or more restful, or the amplitudes are turned down,
more restful illumination by means of the driver information and display system 61 such that, for example, the brightness is controlled as a function of the environmental conditions,
the driver is offered an easier route by means of a navigation system 63, for example a so-called senior route, in which only turns to the right are required,
if high outside noise levels are detected because the side windows are open, these are automatically closed by means of a drive to the door controller 73; in this case, it is also possible to provide for the sliding roof to be closed,
the output of the fuel consumption from a journey computer that is integrated in the driver information and display system 61 can be suppressed,
if an anti-collision control system 82 (ACC system) is provided, increasing the safety separation from the vehicle traveling in front, smooth approach to the vehicle traveling in front and a reduction in the speed setting lead to a reduction in the workload on the driver; an acoustic warning can also be emitted at a relatively low volume, and warnings such as these can also be produced even at an earlier stage. If no such ACC system 82 is active, the activation of systems such as this can be proposed to the user, or else it can be activated automatically when the detected workload values are high. The stated measures can also be implemented by appropriate control of a Tempomat 83,
assistance systems 80 can also be switched on automatically in order to reduce the workload on the driver. These may include the already mentioned navigation system 63 or 81, the ACC system 82 and the Tempomat system 83. In addition, a lane changing assistant 84, a bend warning system 85, a stop and go assistant 86, a lane assistant 87 which automatically keeps the vehicle in its lane, a braking assistant 88 which increases the braking force as a function of the rate at which the brake pedal is operated, or an automatic braking system 89 which automatically prevents acceleration of the vehicle or automatically reduces the speed or initiates a braking process, can also be provided, and
finally, an olfactory device 77 with a metering and distribution device controller can also be used in order in this way to reduce the workload on the driver, with olfactory substances such as these, such as lavender, camphor or lemon, being introduced into the vehicle interior.

Certain environmental conditions, for example driving at night, in rain or when other vehicles are approaching, can also lead to a mean driver-independent workload WLᵢ such that a corresponding measure oₗₖ is initiated by the workload control unit 50, for example by preventing the outputting of any visual information in order in this way to avoid producing any additional visual distraction. Furthermore, when appropriately disposed drivers drive into a tunnel, this can also lead to a high driver-dependent workload WL, if this information is known to the system. One measure to reduce the workload is to reduce the volume of the audio systems or to change the tone so as to produce a more restful sound. Finally, on entering a tunnel, it is in general possible to provide for recirculation air switching to be activated, and for side windows and possibly, the sliding roof to be closed.

In addition, certain driver dispositions which are entered using the input unit 32 can also lead to individual workload levels. If, by way of example, the state “generally worried” is entered, warning signals are emitted with less alarming, more discreet tones, warning messages with a low priority are notified as information, which can be called up by the user himself at the given time.

Driver actions or driving maneuvers such as high speeds, large steering angles or severe acceleration or extreme braking processes can likewise lead to high workloads independently of the driver state, which likewise lead to appropriate measures oₗₖ to reduce the workload, such as suppression of warning messages of load priority, telephone calls not being passed through, or suppression of the display of other additional information.

Examples in which a workload level is present which is below the lower intended workload WLᵤ (see FIG. 1) will now be described in the following text.

If, by way of example, the driver has to cope with a difficult road section, and has not previously had to cope with any difficult driving maneuvers, that is to say the driving task until then was highly monotonous, it can be assumed that the driver-independent workload WLᵢ is low, so that a low workload WL overall is present with corresponding physiological measurement values. Preactivation of the driver can take place as a measure uₗₖ by appropriate driving of the driver information and display system 61 by the workload control unit 50, by outputting information messages or a warning tone. This could also be achieved by appropriately driving a navigation system 63 or 81.

Bends with a specific bend radius and a specific speed may be regarded as a difficult road section, as well as driving onto and leaving high-speed roads and major roads and, finally and additionally, entering built-up areas or traffic circles.

If the workload WL is particularly low and is in the region of the lower minimum workload limit WLₘᵢₙ (see FIG. 1), would thus indicate a risk of the driver going to sleep, the driver can be activated by means of appropriate control of the driver information and display system 61 and of the audio system 62 and, possibly, of the navigation system 63 or 81, by outputting visual and audible signals and information, so that the driver's workload is brought back to the area B1 (see FIG. 1). A corresponding situation also applies when “high-speed road” is detected as an environmental characteristic or “average to low speed” is detected as a driving maneuver and the physiological measurement values indicate fatigue or monotony.

The following measures uₗₖ are implemented by driving the vehicle systems 60, 70, 80 and 90 by means of the workload control unit 50 in order to increase the workload on the driver;
the climate control 72 can be used to decrease the internal temperature, to increase the fan effect, possibly to direct the fan effect on the upper body or the head of the driver, or to switch on steering wheel heating, and/or to set a higher temperature.
the olfactory device 77 can emit substances which have olfactory stimulating effects into the vehicle interior, such as natural substances, for example eucalyptus, peppermint or lemon, or else synthetic substances with a stimulating effect. Increased oxygen introduction also leads to a workload increase, and thus to an improvement in driver performance.
setting the audio system 62 to a louder volume, a harsher tone or a different tone or spatial effect, for example from small room size to a large room size,
making the lighting intensity of displays by means of the driver information and display system 61 brighter,
using the seat control 71 to adjust the inclination of the backrest, to reduce the side support in driving-dynamic seat, or, overall, to make the cushioning of the seat harder, for example in the case of orthopedic seats,
using the door controller 73 to open side windows, and possibly also to open a sliding roof,
production of steering wheel vibration or changing the height setting of the steering wheel by means of a controller 74,
the same controller 74 can also be used to make the steering heavier, or to produce an appropriate steering wheel correction torque if there is a threat of departure from the lane,
using the suspension control 75 to set harder suspension damping.
production of a tactile pedal signal for the accelerator pedal by means of a controller 76, by increasing the resetting force of the accelerator pedal in order to indicate that a speed reduction has been applied,
outputting information of any type by means of the driver information and display system 61, the audio system 62 and the navigation system 63 or 81. For example, the radio or CD player can thus be switched on, or information can be emitted about tourist sites in the close vicinity, traffic messages or information relating to the vehicle.
the navigation system 63 or 81 can be used to offer a difficult route to reach the destination or else to indicate parking lots or good hotel facilities in the immediate vicinity,
when an anti-collision system (ACC system) is activated, the speed setting can be increased, acoustic warnings can be emitted more loudly or else warnings can be emitted earlier, or else the anti-collision control function or the Tempomat function can be deactivated automatically,
further activated assistance systems can also be switched off, for example the lane changing assistant 84, the bend warning system 85, the stop and go assistant 86, the lane assistant 87, the braking assistant 88, or the automatic braking system 89,
if the vehicle at road sign identification, the amount of information offered can be increased by recording all road signs and their indication.

If the workload levels are extreme, that is to say they are below the low minimum workload limit WLₘᵢₙ or above the upper maximum workload limit WLₘₐₓ (see FIG. 1), indicating either a high load with a risk of driver collapse or driver fatigue, other road users can be activated by means of a control unit 90 for production of external warning signals, for example by switching on the hazard blinker system, the horn, flashing headlights, the braking light or dipped headlights.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-40. (canceled)

41. A method for influencing the load on a driver while driving a motor vehicle, comprising the steps:
determining a workload (WL), from physiological driver data detected by means of sensors,
comparing the determined workload (WL) with a predetermined intended workload (WLₒₚₜ),
if the determined workload (WL) is less than the predetermined workload where WL<WLₒₚₜ indicates that the driver is underloaded, increasing the load on the driver by at least one of producing at least on of visual and audible and tactile and olfactory signals by controlling at least one vehicle system, and by increasing at least one of visual and audible and tactile and olfactory signals which have already been produced, and by changing their signal quality by controlling at least one vehicle system, and
if the determined workload (WL) is greater than the predetermined workload where WL>WLₒₚₜ the driver is overloaded, preventing any increase in the load on the driver by at least one of providing driver information and display systems in the motor vehicle in such a way that the output of at least one of visual and audible and tactile and olfactory signals is completely suppressed or partially suppressed or output at a later time.

42. A method for influencing the load on a driver while driving a motor vehicle, comprising the steps:
determining a workload (WL), from physiological driver data detected by means of sensors,
comparing the determined workload (WL) with a predetermined intended workload (WLₒₚₜ),
if the determined workload (WL) is less than the predetermined workload where WL<WLₒₚₜ indicates that the driver is underloaded, increasing the load on the driver by at least one of producing at least on of visual and audible and tactile and olfactory signals by controlling at least one vehicle system, and by increasing at least one of visual and audible and tactile and olfactory signals which have already been produced, and by changing their signal quality by controlling at least one vehicle system, and
if the determined workload (WL) is greater than the predetermined workload where WL>WLₒₚₜ the driver is overloaded, reducing the load on the driver by at least one of reducing and changing at least one of the signal strength and the signal quality of visual and audible and tactile and olfactory signals which have already been produced, and by controlling at least one vehicle system, and by offering the use of a driver assistance system, and by outputting appropriate information to the driver.

43. A method for influencing the load on a driver while driving a motor vehicle, comprising the steps:
determining a workload (WL), from physiological driver data detected by means of sensors,
comparing the determined workload (WL) with a predetermined intended workload (WLₒₚₜ),
if the determined workload (WL) is less than the predetermined workload where WL<WLₒₚₜ indicates that the driver is underloaded, increasing the load on the driver by at least one of producing at least on of visual and audible and tactile and olfactory signals by controlling at least one vehicle system, and by increasing at least one of visual and audible and tactile and olfactory signals which have already been produced, and by changing their signal quality by controlling at least one vehicle system, and
if the determined workload (WL) is greater than the predetermined workload where WL>WLₒₚₜ the driver is overloaded, reducing the load on the driver by at least one of reducing and changing at least one of the signal strength and the signal quality of visual and audible and tactile and olfactory signals which have already been produced, and by controlling at least one vehicle system, and by activation of at least one driver assistance system.

44. The method as claimed in claim 41, wherein, if the driver is still overloaded, reducing the load on the driver by at least one of reducing and changing at least one of the signal strength and the signal quality of visual and audible and tactile and olfactory signals which have already been produced, and by controlling at least one vehicle system, and by offering the use of a driver assistance system, and by outputting appropriate information to the driver.

45. The method as claimed in claim 41, wherein, if the driver is still overloaded, reducing the load on the driver by at least one of reducing and changing at least one of the signal strength and the signal quality of visual and audible and tactile and olfactory signals which have already been produced, and by controlling at least one vehicle system, and by activation of at least one driver assistance system.

46. The method as claimed in claim 42, wherein, if the driver is still overloaded, reducing the load on the driver by at least one of providing driver information and display systems in the motor vehicle in such a way that the output of at least one of visual and audible and tactile and olfactory signals is completely suppressed or partially suppressed or output at a later time.

47. The method as claimed in claim 42, wherein, if the driver is still overloaded, the load on the driver is reduced by activating the driver assistance system.

48. The method as claimed in claim 43, wherein, if the driver is still overloaded, the load on the driver is reduced by providing at least one of driver information and display systems in the motor vehicle in such a way that the output of at least one of visual and audible and tactile and olfactory signals is suppressed, or output at a later time.

49. The method as claimed in claim 41, wherein the driver system is driven in such a way that at least two signals, which correspond to different driver sense channels, are produced successively in order to stimulate different driver sense channels.

50. The method as claimed in claim 41, wherein a lower intended workload (WLᵤ) is predetermined where WLᵤ<WLₒₚₜ and the load on the driver is increased if the workload (WL) is determined to be WL<WLᵤ.

51. The method as claimed in claim 41, wherein an upper intended workload (WLₒ) is predetermined where WLₒ>WLₒₚₜ, and if the workload (WL) is determined to be WLₒ<WL, the increase in the load on the driver is prevented, or the load on the driver is reduced.

52. The method as claimed in claim 41, wherein a lower minimum limit workload (WLₘᵢₙ) is predetermined, where WLₘᵢₙ<WLᵤ and WLₘᵢₙ<WLₒₚₜ and an acoustic and/or optical and/or tactile and/or olfactory warning signal is produced when a determined workload (WL) where WL<WLₘᵢₙ indicates that there is a risk of the driver going to sleep.

53. The method as claimed in claim 52, wherein other road users are warned by acoustic and visual warning signals.

54. The method as claimed in claim 41, wherein an upper maximum limit workload (WLₘₐₓ) is predetermined where WLₒ<WLₘₐₓ and WLₒₚₜ<WLₘₐₓ, and other road users are warned by acoustic and visual warning signals when a determined workload (WL) where WLₘₐₓ<WL indicates that there is a risk of the driver collapsing.

55. The method as claimed in claim 54, wherein an automatic vehicle braking system is activated.

56. The method as claimed in claim 41, wherein any increase in the load on the driver is prevented by prioritizing warning messages and by driving driver information systems in such a way that warning messages with a low priority are suppressed, or are output at a later time.

57. The method as claimed in claim 41, wherein any increase in the load on the driver is prevented by suppressing the signaling of the reception of telephone calls, SMS messages, E-mails and traffic messages into the vehicle information system, or by outputting them at a later time.

58. The method as claimed in claim 41, wherein any increase in the load on the driver is prevented by prioritizing the displays on a display system in the vehicle and by switching off the illumination of a display with a low priority, or by reducing its light intensity.

59. The method as claimed claim 41, wherein controllers for the air-conditioning are used as a vehicle system to increase or for reducing the load on the driver.

60. The method as claimed in claim 41, wherein controllers for the vehicle seats are used as a vehicle system to increase or to reduce the load on the driver.

61. The method as claimed in claim 41, wherein controllers for an audio system in the vehicle are used to increase or to reduce the load on the driver.

62. The method as claimed in claim 41, wherein controllers for adjustment of the illumination for the display instruments are used to increase or to reduce the load on the driver.

63. The method as claimed in claim 41, wherein door controllers are used as a vehicle system to increase or to reduce the load on the driver.

64. The method as claimed in claim 41, wherein a navigation system is used as a vehicle system to increase or to reduce the load on the driver.

65. The method as claimed in claim 41, wherein controllers for information systems are used as a vehicle system to increase or to reduce the load on the driver.

66. The method as claimed in claim 41, wherein a controller for anti-collision control (ACC) is used as a vehicle system to increase or to reduce the load on the driver.

67. The method as claimed in claim 41, wherein a controller for suspension control is used as a vehicle system to increase or to reduce the load on the driver.

68. The method as claimed in claim 41, wherein controllers for road sign identification are used as a vehicle system to increase or to reduce the load on the driver.

69. The method as claimed in claim 41, wherein controllers for adjusting the steering wheel position and to produce steering wheel vibration are used as a vehicle system to increase the load on the driver.

70. The method as claimed claim 41, wherein a controller for the servosteering is used as a vehicle system to increase the load on the driver.

71. The method as claimed in claim 41, wherein driver assistance systems which are switched off in the active state are used to increase the load on the driver.

72. The method as claimed in claim 41, wherein the driver's biographical data is also used for determining the workload on the driver.

73. The method as claimed in claim 41, wherein vehicle state data is additionally detected by sensors for determining the workload on the driver.

74. The method as claimed in claim 41, wherein the driver's driving maneuvers and/or driver actions are detected by sensors for determining the workload on the driver.

75. The method as claimed in claim 41, wherein environmental data such as the type of road, the state of the road, the traffic and the environment are detected by sensors for determining the workload on the driver.

76. The method as claimed in claim 41, wherein, when the load on the driver is increased, the driver is informed of this by production of a signal, in particular a visual and/or audible signal.

77. An apparatus for carrying out the method as claimed in claim 41, comprising:
a sensor unit for detection of the driver's physiological data said sensor unit connected via a bus system to an on-board computer for determining and evaluating the workload (WL) on the driver, and
a workload control unit driving at least one vehicle system in accordance with first measures associated with the evaluation result (WL, WLⱼ) on the basis of an evaluation result (WL, WLⱼ) produced by an on-board computer and second measures (oₗₗ . . . . oₘₙ, uₗₗ . . . uₘₙ) which are stored in a measure memory.

78. The apparatus as claimed in claim 77, further including a vehicle state and vehicle environment sensor system connected to the on-board computer.

79. The apparatus as claimed in claim 77, wherein the on-board computer is connected to an input appliance for inputting the driver's biographical data.

80. The apparatus as claimed in claim 77, further including a driver activity sensor system connected to the on-board computer.
